(19) United States
(12) Patent Application Publication
(10) Pub. No.: US 2016/0275810 A1
(43) Pub. Date: Sep. 22, 2016

(54) Integrated interactively teaching platform system

(71) Applicant: HONG DING EDUCATIONAL TECHNOLOGY CO., LTD., Taipei City (TW)

(72) Inventors: Sheng-Chiu Pai, Taipei City (TW); Ya-Yu Tung, Taipei City (TW)

(73) Assignee: HONG DING EDUCATIONAL TECHNOLOGY CO., LTD., Taipei City (TW)

(21) Appl. No.: 15/061,885

(22) Filed: Mar. 4, 2016

(30) Foreign Application Priority Data
Mar. 19, 2015 (TW) 104108728

(51) Int. Cl. G09B 19/00; G09B 5/02

(52) U.S. Cl. CPC G09B 19/00; G09B 5/02

(57) ABSTRACT

An integrated interactively teaching platform system comprising a pre-class interactive data compiling device, a in-class interactive data compiling device, and an after-class interactive data assessing device, wherein the pre-class interactive data compiling device generates an interactive teaching plan and an evaluating test paper object which can be used in class by the in-class interactive data compiling device. The in-class interactive data compiling device performs a teaching service and an evaluation test with an evaluating test paper object, and tracks the evaluating test paper object to obtain an evaluation result. The after-class interactive data assessing device generates an assessing record according to the evaluation result to provide teachers with the current study status of students.

### FIELD OF THE INVENTION

The present invention relates to an online teaching platform, and more particularly to an integrated interactively teaching platform system.

### BACKGROUND OF THE INVENTION

With the development of Internet technology in recent years, teaching platforms for teaching and learning on the internet become available, wherein on the platforms, teachers offer auxiliary teaching materials such as instant images, or files that are prepared in advance including videos and briefings to students.

However, in such teaching mode, instead of directly interact with the teachers, the students receive information unilaterally. Therefore, teachers cannot know the learning status of students from the class. Thus, it is necessary to provide an integrated interactively teaching platform system which can obtain an evaluation result from the class.

### SUMMARY OF THE INVENTION

Accordingly, an object of the present invention is to provide an integrated interactively teaching platform system, which can obtain an evaluation result from the class.

The technical means adopted by the present invention to overcome the drawbacks in prior art provides an integrated interactively teaching platform system, comprising:
a pre-class interactive data compiling device including an interactive teaching plan compiling means, an interactive question bank compiling means and an interactive evaluating test paper compiling means, wherein the interactive teaching plan compiling means edits and compiles a teaching resource to obtain an interactive teaching plan, the interactive question bank compiling means establishes a question bank, and the interactive evaluating test paper compiling means edits an evaluating test paper object according to the question bank and/or another teaching resource;
a in-class interactive data compiling device including an interactive teaching plan processing means and an interactive evaluating means, wherein the interactive teaching plan processing means selects a in-class interactive teaching plan from the interactive teaching plan and assigns the selected in-class interactive teaching plan to a teacher end and a student end which corresponds to the teacher end in such a manner that the assigned selected in-class interactive teaching plan is displayed in the student end, after which an immediate test is performed to obtain an immediate test result, and the interactive evaluating means selects a in-class evaluating test paper object from the evaluating test paper object so as to perform an evaluation test and tracks the evaluation test to obtain an evaluation result;
an after-class interactive data assessing device which generates an assessing record according to the evaluation result.

In one embodiment of the present invention, an integrated interactively teaching platform system is provided, wherein the teaching resource is a digital video information, a digital picture information, a digital audio information, a digital text information, or a combination thereof.

In one embodiment of the present invention, an integrated interactively teaching platform system is provided, wherein the question bank is a question bank for multi-choice questions, a question bank for multi-select questions, a question bank for cloze tests, a question bank for true or false questions, or a combination thereof.

In one embodiment of the present invention, an integrated interactively teaching platform system is provided, wherein the interactive teaching plan has at least one teaching plan tag information.

In one embodiment of the present invention, an integrated interactively teaching platform system is provided, wherein the question bank has at least one question bank tag information.

In one embodiment of the present invention, an integrated interactively teaching platform system is provided, wherein the evaluating test paper object has at least one test paper tag information.

In one embodiment of the present invention, an integrated interactively teaching platform system is provided, wherein the interactive evaluating means selects the in-class evaluating test paper object from the test paper tag information.

In one embodiment of the present invention, an integrated interactively teaching platform system is provided, wherein the immediate test result is a digital handwriting information or a digital text information.

In one embodiment of the present invention, an integrated interactively teaching platform system is provided, wherein the evaluation result is a digital text information, an answer record information, or a combination thereof.

By the technical means adopted by the present invention, the pre-class interactive data compiling device, the in-class interactive data compiling device, and the after-class interactive data assessing device are integrated together. The interactive evaluating means selects a in-class evaluating test paper object from the evaluating test paper object which is prepared prior to class to perform an evaluation test for the students and tracks the evaluation test to obtain an evaluation result of the students, wherein the evaluation results obtained during a class can provide teachers to know the short-term learning status of the students, and the evaluation results obtained after a class can provide teachers to know the long-term learning performances of the students.

In other embodiments, the in-class evaluating test paper object is a quiz performed according to the interactive teaching plan, in which the in-class evaluating test paper object can immediately obtain the evaluation results in class so as to provide teachers with the current learning status of the students as the reference for adjusting the interactive teaching plan.

The specific embodiments adopted by the present invention will be further explained by referring to the following detailed description of the preferred embodiments and the accompanying drawings.

### BRIEF DESCRIPTION OF THE DRAWINGS

FIG. 1 is a block diagram illustrating an integrated interactively teaching platform system according to a first embodiment of the present invention.

FIG. 2 is a block diagram illustrating the integrated interactively teaching platform system according to the first embodiment of the present invention.

FIG. 3 is a schematic view illustrating the integrated interactively teaching platform system according to the first embodiment of the present invention being used in class.

FIG. 4 is a schematic view illustrating an integrated interactively teaching platform system according to a second embodiment of the present invention being used in class.

### DETAILED DESCRIPTION OF THE PREFERRED EMBODIMENTS

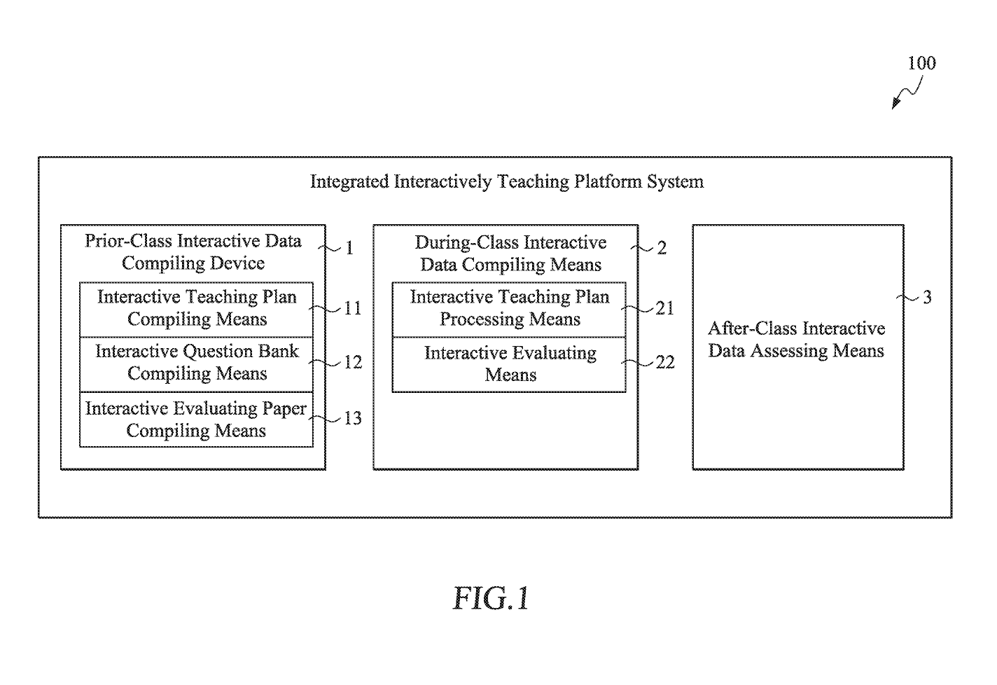

The implementation of the present invention is described as follows with reference to FIGS. 1 to 4. The descriptions herein are not to be construed as limitations on the present invention, but are to be construed as illustration of the preferred embodiments of the present invention.

Please refer to FIGS. 1 to 4. According to a first embodiment of the present invention, an integrated interactively teaching platform system 100 comprises a pre-class interactive data compiling device 1, a in-class interactive data compiling device 2, and an after-class interactive data assessing device 3.

The pre-class interactive data compiling device 1 includes an interactive teaching plan compiling means 11, an interactive question bank compiling means 12, and an interactive evaluating test paper compiling means 13, wherein the interactive teaching plan compiling means 11 edits and compiles a teaching resource D1 to obtain an interactive teaching plan P, the interactive question bank compiling means 12 edits and compiles another teaching resource D2 to establish a question bank Q, and the interactive evaluating test paper compiling means 13 edits an evaluating test paper object E according to the question bank Q and/or another teaching resource D3.

The in-class interactive data compiling device 2 includes an interactive teaching plan processing means 21 and an interactive evaluating means 22, wherein the interactive teaching plan processing means 21 selects a in-class interactive teaching plan P1 from the interactive teaching plan P and assigns the selected in-class interactive teaching plan P1 to a teacher end T and a student end S which corresponds to the teacher end T in such a manner that the assigned selected in-class interactive teaching plan P1 is displayed in the student end S, after which an immediate test Z0 is performed to obtain an immediate test result R0 of the immediate test Z0, and the interactive evaluating means 22 selects a in-class evaluating test paper object L from the evaluating test paper object E so as to perform a score test Z and tracks the score test Z to obtain an evaluation result R.

The after-class interactive data assessing device 3 generates an assessing record O according to the evaluation result R.

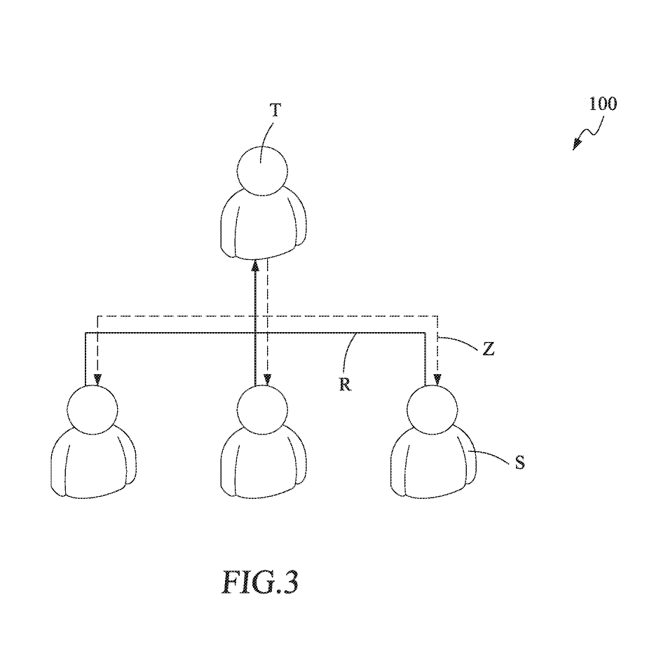

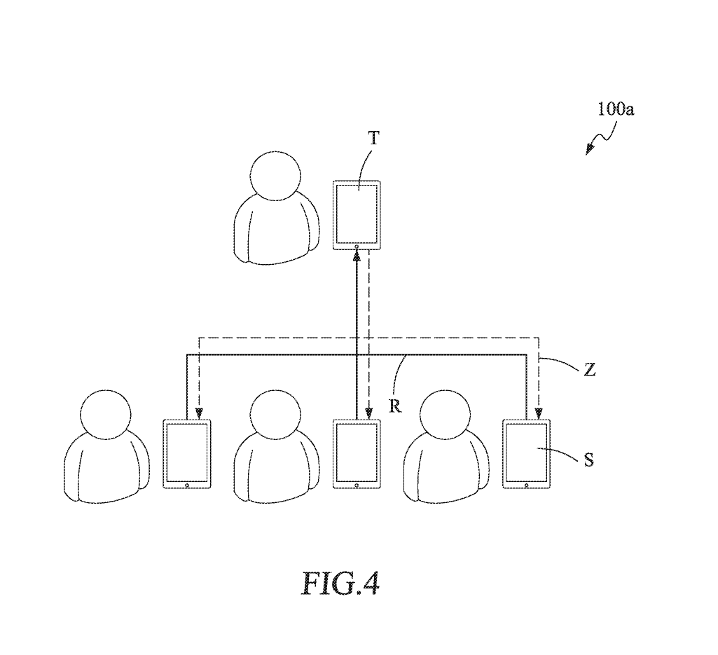

A teacher end T performs an interactive teaching for a student end S by using the pre-class interactive data compiling device 1, the in-class interactive data compiling device 2, and the after-class interactive data assessing device 3. In the first embodiment shown in FIG. 3, the teacher end T and the student end S can be virtual identities in the integrated interactively teaching platform system 100 in which the teacher end T and the student end S interact on the internet. In an integrated interactively teaching platform system 100a according to a second embodiment shown in FIG. 4, the teacher end T and the student end S can also be electronic whiteboards, computers, smart phones or other physical devices operated by the teachers and the students, in which the teacher end T and the student end S interact via the internet, transmission lines, infrared ray, Bluetooth or other wired or wireless methods.

The integrated interactively teaching platform system 100 according to the first embodiment of the present invention, the teaching resource D1, D2, D3 is a digital video information, a digital picture information, a digital audio information, a digital text information, or a combination thereof. The teaching resource D1, D2, D3 is the resource obtained from the internet or uploaded by a user, in which the digital information are edited and compiled to generate the interactive teaching plain P, the question bank Q, and the evaluating test paper object E.

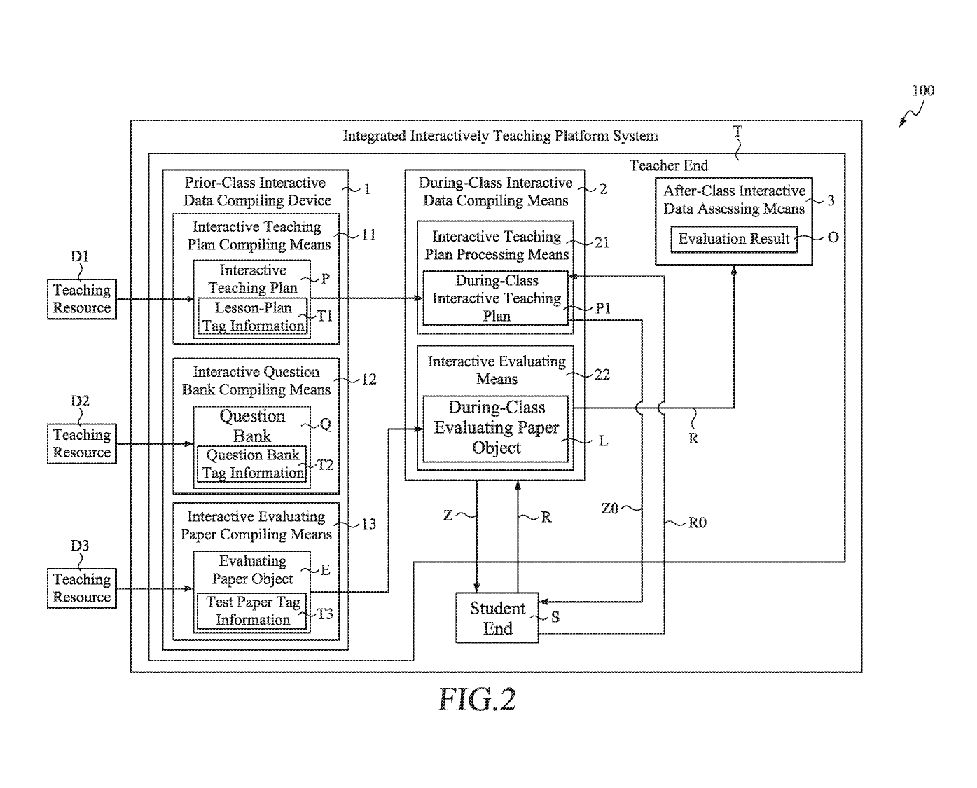

As shown in FIG. 2 which illustrates the integrated interactively teaching platform system 100 according to the first embodiment of the present invention, wherein the interactive teaching plan P has at least one teaching plan tag information T1. The teacher end T edited the teaching plan tag information T1 such as the academic year, the academic term, the grade, the subject, and the lecture scope on the interactive teaching plan P. With the help of the teaching plan tag information T1, the teachers can quickly select the required interactive teaching plan. Besides, by using the interactive teaching plan compiling means 11, the teachers can share the interactive teaching plan P with other teachers or get the interactive teaching plan P shared by other teachers.

In the integrated interactively teaching platform system 100 according to the first embodiment of the present invention, the question bank Q is a question bank for multi-choice questions, a question bank for multi-select questions, a question bank for cloze tests, a question bank for true or false questions, or a combination thereof, wherein the question bank Q can thus offer different test types.

As shown in FIG. 2 which illustrates the integrated interactively teaching platform system 100 according to the first embodiment of the present invention, the question bank Q has at least one question bank tag information T2, which is the tag information such as the academic year, the academic term, the grade, the subject, the scope, the test type, and the degree of difficulty edited on the question bank Q by the teacher end T. With the help of the question bank tag information, the teachers can quickly select the required question bank Q.

The integrated interactively teaching platform system 100 according to the first embodiment of the present invention can obtain the evaluating test paper object E by directly editing and compiling the teaching resource D3 or the question bank Q, or can generate the evaluating test paper object E by using the combination of the teaching resource D3 and the question bank Q.

As shown in FIG. 2 which illustrates the integrated interactively teaching platform system 100 according to the first embodiment of the present invention, the evaluating test paper object E has at least one test paper tag information T3, which is tag information such as the academic year, the academic term, the grade, the subject, the scope, and the degree of difficulty edited on the evaluating test paper object E by the teacher end. With the help of the test paper tag information T3, the teachers can quickly select the required evaluating test paper object. Besides, by using the interactive evaluating test paper compiling means 13, the teachers can share the evaluating test paper object E with other teachers, or get the evaluating test paper objects E shared by other teachers.

As shown in FIG. 2 which illustrates the integrated interactively teaching platform system 100 according to the first embodiment of the present invention, the interactive teaching plan processing means 21 is provided for the teachers to select the required in-class interactive teaching plan P1 from the interactive teaching plan P according to the teaching plan tag information T1, and the interactive teaching plan processing means 21 assigns the in-class interactive teaching plan P1 to different classes or groups. The interactive teaching plan processing means 21 displays the in-class interactive teaching plan P1 for the students in such a manner that the content of the in-class interactive teaching plan P1 is synchronously displayed at the student end S. In the second embodiment, the content of the in-class interactive teaching plan P1 is displayed on the screen of the teacher end T, and is synchronously displayed on the screen of student end S. Moreover, when the teachers add annotations on the in-class interactive teaching plan P1, the added annotation can be synchronously displayed on the screen of the student end S.

As shown in FIG. 2 which illustrates the integrated interactively teaching platform system 100 according to the first embodiment of the present invention, the interactive teaching plan processing means 21 displays the in-class interactive teaching plan P1 for the students, after which the immediate test Z0 can be performed. The immediate test Z0 can be a short answer question, a cloze test or a multiple-choice question, and an immediate test result R0 of the immediate test Z0 can be obtained immediately in class. Specifically, the immediate test result R0 can be a digital handwriting information or a digital text information, which provided the teachers with the status of the students as the reference for adjusting the in-class interactive teaching plan P1.

As shown in FIG. 2 which illustrates the integrated interactively teaching platform system 100 according to the first embodiment of the present invention, the interactive evaluating means 22 is provided for the teachers to select the required in-class evaluating test paper object L according to the test paper tag information T3, in which the in-class evaluating test paper object L is used to perform a score test Z in class from the evaluating test paper object E. The teachers can immediately obtain the evaluation result R of the student end. Specifically, the evaluation result R can be a digital text information, an answer record information, or a combination thereof. According to the evaluation result R, the teachers can understand the learning status of the students and perform a test review.

As shown in FIG. 2, the integrated interactively teaching platform system 100 according to the first embodiment of the present invention, the assessing record O is the statistics according to the evaluation result R of a single-score test Z, in which the assessing record O provides the teachers with the short-term learning performance of the students. Besides, the assessing record O can be the aggregate statistics according to the evaluation result R of the multi-score test Z, in which the assessing record O provides the teachers with the long-term learning performance of the students.

The above description is only the explanation of the preferred embodiments of the present invention. However, a person with ordinary skill in the art may make various modifications to the present invention. Those modifications shall still fall within the spirit and the scope defined by the appended claims.

What is claimed is:

1. An integrated interactively teaching platform system, comprising:
a pre-class interactive data compiling device including an interactive teaching plan compiling means, an interactive question bank compiling means and an interactive evaluating test paper compiling means, wherein the interactive teaching plan compiling means edits and compiles a teaching resource to obtain an interactive teaching plan, the interactive question bank compiling means establishes a question bank, and the interactive evaluating test paper compiling means edits an evaluating test paper object according to the question bank and/or another teaching resource;
an in-class interactive data compiling device including an interactive teaching plan processing means and an interactive evaluating means, wherein the interactive teaching plan processing means selects a in-class interactive teaching plan from the interactive teaching plan and assigns the selected in-class interactive teaching plan to a teacher end and a student end which corresponds to the teacher end in such a manner that the assigned selected in-class interactive teaching plan is displayed in the student end, after which an immediate test is performed to obtain an immediate test result, and the interactive evaluating means selects a in-class evaluating test paper object from the evaluating test paper object so as to perform an evaluation test and tracks the evaluation test to obtain an evaluation result;
an after-class interactive data assessing device which generates an assessing record according to the evaluation result.

2. The integrated interactively teaching platform system of claim 1, wherein the teaching resource is a digital video information, a digital picture information, a digital audio information, a digital text information or a combination thereof.

3. The integrated interactively teaching platform system of claim 1, wherein the question bank is a question bank for multi-choice questions, a question bank for multi-select questions, a question bank for cloze tests, a question bank for true or false questions or a combination thereof.

4. The integrated interactively teaching platform system of claim 1, wherein the interactive teaching plan has at least a teaching plan tag information.

5. The integrated interactively teaching platform system of claim 1, wherein the question bank has at least a question bank tag information.

6. The integrated interactively teaching platform system of claim 1, wherein the evaluating test paper object has at least a test paper tag information.

7. The integrated interactively teaching platform system of claim 6, wherein the interactive evaluating means selects the in-class evaluating test paper object from the test paper tag information.

8. The integrated interactively teaching platform system of claim 1, wherein the immediate test result is a digital handwriting information or a digital text information.

9. The interactive teacher and student service platform of claim 1, wherein the evaluation result is a digital text information, an answer record information or a combination thereof.
